(19) United States
(12) Patent Application Publication
(10) Pub. No.: US 2022/0193699 A1
(43) Pub. Date: Jun. 23, 2022

(54) SKIN-BEAUTIFYING SHOWER DEVICE

(71) Applicant: JOMOO KITCHEN&BATH CO., LTD., Fujian (CN)

(72) Inventors: Xiaofa LIN, Fujian (CN); Xiaoshan LIN, Fujian (CN); Guangwei MAO, Fujian (CN); Kunpeng HUANG, Fujian (CN)

(73) Assignee: JOMOO KITCHEN&BATH CO., LTD., Fujian (CN)

(21) Appl. No.: 17/599,564

(22) PCT Filed: Aug. 12, 2019
(86) PCT No.: PCT/CN2019/100139

§ 371 Date: Sep. 29, 2021

(30) Foreign Application Priority Data
Apr. 3, 2019 (CN) 2019 20447768.1

(51) Int. Cl. B05B 1/18; E03C 1/046

(52) U.S. Cl. CPC B05B 1/18; B05B 15/63; E03C 1/046

(57) ABSTRACT

A skin-beautifying shower device includes a toiletries container and a switching assembly provided in a handle. The toiletries container includes a housing and a storage tube. The housing is provided with a water inlet end and a water outlet end. The storage tube is placed in the housing with at least one end thereof being enclosed, and a gap is defined between the outer wall of the storage tube and the inner wall of the housing to form a first water passage communicating with the water inlet end and the water outlet end. The switching assembly includes a rotating disc, a water splitter piece, and a toggle. The rotating disc is provided with a first water outlet hole communicating with the first water passage. The water splitter piece is provided with a second water outlet hole communicating with the water outlet. The toggle extends out of the handle and drives the rotating disc to rotate and to control a communication area between the first and second water outlet holes.

### BACKGROUND

### Technical Field

The disclosure relates to the field of showers, in particular, to a skin-beautifying shower device.

### Description of Related Art

At present, most of the skin-beautifying shower devices on the market use externally-hanging medicament tubes or insert-type medicament tablets to achieve the effect of skin beautifying and caring after the medicament is dissolved. However, the external-hanging skin-beautifying shower devices are bulky and inconvenient to be held. Further, the connection between the medicament tube and the shower device body is unstable, the solution may not flow out smoothly, and a poor user experience is thus provided. The shower devices adopting the insert-type medicament tablets exhibit problems such as excessively small capacity of the toiletries and excessively short service life, so this type of shower devices is required to be frequently replaced, which is not convenient for users to use for a long time.

Moreover, the skin-beautifying shower devices on the market rarely have the function of flow adjustment, so users cannot perform spraying according to their own needs, which often results in excessive use or insufficient use of medicaments. But in terms of the skin-beautifying shower devices with the function of flow adjustment, this type of shower devices usually requires a user to hold the shower device with one hand and rotate to adjust the device with the other hand. Such an operation is not convenient for one-handed operation, and the operation requires a relatively large force. It is inconvenient for a user to apply force while showering since it is likely to slip during the operation, so a poor user experience is also provided.

### SUMMARY

The goal of the disclosure is to overcome the defects or problems mentioned in the prior art and thus provides a skin-beautifying shower device which may be filled with toiletries independently and convenient for a user to control the water flow by one hand according to the user's own needs, thereby not only reducing waste of the toiletries, but also improving the user experience.

To accomplish the foregoing purpose, the following technical solutions are adopted by the disclosure.

The disclosure provides a skin-beautifying shower device including a handle and a showerhead body fixedly connected to the handle. The handle is provided with a water inlet opening, and the showerhead body is provided with a water outlet opening. The skin-beautifying shower device further includes a toiletries container and a switching assembly provided in the handle. The toiletries container includes a housing and storage tube. The housing is provided with a water inlet end and a water outlet end, the storage tube is placed in the housing with at least one end thereof being enclosed, and a gap is defined between an outer wall of the storage tube and an inner wall of the housing to form a first water passage communicating with the water inlet end and the water outlet end. The switching assembly includes a rotating disc, a water splitter piece, and a toggle. The rotating disc is provided with a first water outlet hole communicating with the first water passage, and the water splitter piece is provided with a second water outlet hole communicating with the water outlet opening. The toggle radially extends out of the handle and drives the rotating disc to rotate around an axis of the handle to control a communication area between the first water outlet hole and the second water outlet hole.

Preferably, the switching assembly further includes a water outlet body, and the water outlet body is non-rotatably connected to the water splitter piece. The water outlet body is provided with a water outlet channel communicating with the water outlet opening, the water splitter piece is disposed between the rotating disc and the water outlet body, and the second water outlet hole always communicates with the water outlet channel.

Preferably, the water inlet end of the housing communicates with the water inlet opening. A gap is defined between an outer wall of the housing and an inner wall of the handle to form a second water passage always communicating with the water inlet opening. A side wall of the water outlet body is provided with a water passing hole always communicating with the second water passage.

Preferably, the switching assembly further includes a toggle base, and the toggle is engaged with the toggle base. The toggle base is provided with a shaft hole, and the rotating disc is provided with an inserted shaft. The inserted shaft of the rotating disc is non-rotatably connected to the shaft hole of the toggle base after penetrating through the water splitter piece and the water outlet body.

Preferably, the outer wall of the storage tube is surrounded with a plurality of through holes.

Preferably, the toiletries container is further provided with a water outlet connector. The water outlet connector is provided with a third water passage communicating with the first water passage at one end and communicating with the first water outlet hole at the other end. The water outlet connector and the inner wall of the housing are hermetically connected to the water outlet end of the housing.

Preferably, the storage tube is provided with a toiletries filling hole facing the water outlet end, and the water outlet connector hermetically blocks the toiletries filling hole.

Preferably, the storage tube includes a tube body and a plug, and the plug hermetically blocks one end of the tube body facing the water inlet end.

Preferably, the storage tube further includes a lip-shaped sealing ring, and the lip-shaped sealing ring is disposed on one side of the tube body adjacent to the water inlet end or a protruding portion of the plug protruding towards the water inlet end, such that the lip-shaped sealing ring is hermetically connected to the inner wall of the housing. An opening of the lip-shaped sealing ring faces the water outlet end.

Preferably, at least two groups of the through holes are provided in an axial direction of the storage tube, and each group of the through holes is provided with a plurality of through holes around the outer wall of the storage tube.

Preferably a connecting ring is further provided, the connecting ring is sleeved outside the handle, and the connecting ring is provided with a toggle hole, and the toggle extends out of the toggle hole.

Based on the above description of the disclosure, the disclosure exhibits the following beneficial effects compared to the related art.

1. The toiletries container and the switching assembly in the skin-beautifying shower device are both arranged in the handle, and in this way, the gripping effect of the handle is not affected, and the toiletries container is stably connected to the showerhead body, so continuous water flow is thus be ensured.

The toiletries container includes the housing and storage tube. The storage tube is configured to accommodate the paste-like toiletries, and the adopted paste-like toiletries is required to be dissolved in clean water first before being used and then acts as the toiletries solution after being dissolved. The storage tube is closed at least at one end, that is, the storage tube may be independently filled with toiletries and may be filled with a full tube of toiletries, which greatly increases the filling capacity.

Further, the first water passage is formed between the outer wall of the storage tube and the inner wall of the housing, and the first water passage is used to allow the clean water to flow into the storage tube through the through holes provided on the wall of the tube after flowing into the first water passage, so as to dissolve the paste-like toiletries in the tube. The solution after the toiletries is dissolved flows out to the first water passage through the above-mentioned through holes.

The switching assembly is configured to be used by a user to control the flow amount of the toiletries solution according to his/her own needs, so that the toiletries solution is prevented from being wasted. To be specific, since the rotating disc is provided with the first water outlet hole communicating with the first water passage and the water splitter piece is provided with the second water outlet hole communicating with the water outlet opening, the toiletries solution in the first water passage flows out to the first water outlet hole and then flows out to the water outlet opening of the showerhead body through the second water outlet hole sealedly aligned with the first water outlet hole. Herein, when the user holds the shower device in hand, the user can toggle the toggle to control the outflow amount of the toiletries solution with a single finger, and such a toggling action is labor-saving and effective. After the user toggles the toggle, the rotating disc is driven to rotate about the axis of the handle, such that the rotating disc rotates relative to the water splitter piece. As such, after the first water outlet hole on the rotating disc and the second water outlet hole on the water splitter piece intersect, portions of the two that do not overlap form the water passing through hole for allowing the toiletries solution to flow through. The water passing area of the water passing through hole is the communication area between the first water outlet hole and the second water outlet hole. The size of the communication area depends on the rotating angle of the rotating disc relative to the water splitter piece. When the communication area between the second water outlet hole and the first water outlet hole increases, outflow amount of the toiletries solution increases. When the first water outlet hole and the second water outlet hole are completely misaligned, the outflow of the toiletries solution is stopped. That is, the user may control the water flow by only one hand, and not only the toiletries are prevented from being wasted in this way, the user experience during showering is also improved.

2. The switching assembly further includes the water outlet body, and the water outlet body is non-rotatably connected to the water splitter piece. The water splitter piece is disposed between the rotating disc and the water outlet body, that is, the rotating disc rotates relative to the water outlet body and the water splitter piece. The water outlet channel of the water outlet body and the second water outlet hole of the water splitter piece are kept to communicate with each other, so that stable outflow of the toiletries solution is ensured.

3. A gap is defined between the outer wall of the housing and the inner wall of the handle, so as to form the second water passage always communicating with the water inlet opening. The water passing hole of the side wall of the water outlet body always communicates with the second water passage. That is, the clean water flows into the second water passage through the water inlet opening of the handle and then flows into the water outlet body through the water passing hole arranged on the side wall of the water outlet body to be mixed with the toiletries solution flowing into the water outlet body. The mixed solution then flows out through the water outlet channel to the water outlet opening of the showerhead body.

4. The switching assembly further includes the toggle base, and the toggle base and the rotating disc are non-rotatably connected respectively through the shaft hole and the inserted shaft provided therein. As the shaft hole and the inserted shaft are matched, the toggle base and the rotating disc may not be easily detached, and effectiveness of toggling is thus ensured. Further, one end of the toggle is engaged with the toggle base, and the other end of the toggle radially extends out of the handle, so that after the user toggles the end of the toggle extending out of the handle, the toggle base and the rotating disc connected thereto in a non-rotational manner are driven to rotate, and outflow amount of the toiletries solution may thus be controlled.

5. Since the plurality of the through holes are arranged around the outer wall of the storage tube, water flow may flow from the through holes into the tube in multiple directions. Therefore, even if the through holes in a specific direction are blocked, the subsequent smooth output of the toiletries solution or the re-inflow of the clean water is not affected, so that the smooth water output of the skin-beautifying shower device is ensured as a whole. Further, since the gap required by the first water passage is small, the storage tube may accommodate more toiletries, so the user may be required to fill the tube less frequently.

6. The toiletries container further includes the water outlet connector, and the second water passage provided to the water outlet connector is hermetically connected to the first water passage, so that the solution which is produced after the toiletries is dissolved may flow out through the second water passage. The toiletries container forms a tube-shaped body as a whole through the matching of the water outlet connector and the housing and thus may be independently installed in any suitable shower device handle. After installation, since the shape of the water outlet connector matches the shape of the inner wall of the handle, displacement or separation may not easily occur, and that the stability of the outflow of the toiletries solution is effectively ensured.

7. One end of the storage tube facing the water outlet end is provided with the toiletries filling hole, and the toiletries filling hole has a moderate hole diameter, such that filling may be conveniently carried out by the user, and spilling may not easily occur. Further, the water outlet connector is configured to hermetically block the toiletries filling hole, so that the toiletries solution is prevented from flowing out from the toiletries filling hole, and two ends of the storage tube are both sealed. That is, the toiletries solution may flow to the first water passage only through the through holes arranged on the tube wall of the storage tube to be filtered and then to flow to the second water passage. The paste-like toiletries may thus be fully dissolved into the toiletries solution, and a favorable user experience is thus provided.

8. The storage tube includes the tube body and the plug, and the plug is configured to hermetically block one end of the storage tube facing the water inlet end. The independent toiletries accommodating chamber is formed through the tube body and the plug, so that the storage tube may be independently filled, and the storage tube is then entirely installed inside the housing after the filling is completed.

9. The storage tube further includes the lip-shaped sealing ring. That is, the lip-shaped sealing ring may be arranged in two ways. One way is that the lip-shaped sealing ring is sleeved on one side of the tube body adjacent to the water inlet end, that is, the side wall of the lip-shaped sealing ring abuts against the inner wall of the housing. The other way is that the lip-shaped sealing ring is sleeved on the protruding portion of the plug protruding towards the water inlet end, and the side wall of the lip-shaped sealing ring abuts against the inner wall of the housing as well. Herein, the opening of the lip-shaped sealing ring faces the water outlet end, so that the toiletries solution is ensured to flow out in one direction. That is, the toiletries solution may only flow to the second water passage from the first water passage and may not flow backwards from the first water passage to the water inlet end, and that the toiletries solution is prevented from being wasted and polluting the clean water. The surface of the side wall of the lip-shaped sealing ring facing the water inlet end is the outer side surface, and the surface facing the water outlet end is the inner side surface. Further, the portion of the lip-shaped sealing ring facing the water inlet end is the closing portion, and the portion facing the water outlet end is the opening portion. The lip-shaped sealing ring is made of an elastic material.

The implementation principle of the unidirectional circulation of the lip-shaped sealing ring is as follows. When the clean water flows through the closing portion of the lip-shaped sealing ring from the water inlet end, flowing of the clean water may generate a water pressure on the outer side surface of the lip-shaped sealing ring. The side wall of the lip-shaped sealing ring thereby generates elastic deformation and compresses towards the shaft center due to the action of the water flowing towards the water outlet end. As such, a water passing gap is formed between the side wall of the lip-shaped sealing ring and the inner wall of the housing, and that the clean water is thus allowed to flow into the first water passage.

Further, a water pressure is generated on the inner side surface of the lip-shaped sealing ring after the water flows into the first water passage, so that the side wall of the lip-shaped sealing ring is stretched due to the action of the water flowing towards the water inlet end. The side wall is thereby closely attached to the inner wall of the housing to form water sealing, and that the water flow in the first water passage cannot flow back to the water inlet end.

10. Through the through holes surrounding the outer wall of the storage tube, the clean water in the first water passage flows inside the storage tube through the through holes to dissolve the paste-like toiletries in the tube, so that the tube is always kept in a filled state. Further, since the flow rate in the tube is slower, and the flow rate outside the tube is faster, based on the Venturi principle, the toiletries solution inside the tube may be sucked out from the through holes into the first water passage and then flows out from the second water passage. To be specific, the groups of through holes are arranged in the axial direction of the storage tube, and each group of through holes is provided with a plurality of through holes around the outer wall of the storage tube. The clean water may flow inside the storage tube through each through hole to dissolve the paste-like toiletries, and that the dissolution speed of the paste-like toiletries may thus be significantly improved. Since the plurality of through holes are arranged around the outer wall of the tube body, the risk of poor circulation due to blocking of the through holes in a specific direction or in several directions is reduced, and the normal use of the toiletries container is thus ensured.

11. The connecting ring is sleeved on the junction between the handle and the showerhead body to hermetically connect the handle and the showerhead body. Further, the connecting ring is provided with the toggle hole for the toggle to extend out. That is, the connecting ring is matched with the toggle and the toggle base to achieve a hidden engagement connection, and an appealing appearance of the shower device is thus provided after assembly. The toggling position of the toggle is obviously presented due to the toggle hole, so that it is convenient for the user to determine the toggling direction.

### BRIEF DESCRIPTION OF THE DRAWINGS

To make the technical solutions provided in the embodiments of the disclosure more clearly illustrated, several accompanying drawings required by the embodiments for description are briefly introduced as follows. Obviously, the drawings in the following description are only some embodiments of the disclosure, and for a person having ordinary skill in the art, other drawings can be obtained based on these drawings without inventive effort.

FIG. 1 is an exploded view of a structure according to an embodiment of the disclosure.

FIG. 2 is a schematic cross-sectional view of the structure according to an embodiment of the disclosure.

FIG. 3 is a schematic cross-sectional view of a structure of a toiletries container according to an embodiment of the disclosure.

FIG. 4 is a schematic view of a structure of a storage tube in the toiletries container according to an embodiment of the disclosure.

FIG. 5 is a schematic view of a structure of a water outlet connector in the toiletries container according to an embodiment of the disclosure.

FIG. 6 is a schematic view of a structure of a lip-shaped sealing ring in the toiletries container according to an embodiment of the disclosure.

FIG. 7 is a schematic cross-sectional view of a structure of a switching assembly according to an embodiment of the disclosure.

FIG. 8 is a schematic view of structures of a rotating disc and a water splitter piece in the switching assembly according to an embodiment of the disclosure.

FIG. 9 is a schematic view of a structure of a toggle in the switching assembly according to an embodiment of the disclosure.

FIG. 10 is a schematic view of a structure of a toggle base in the switching assembly according to an embodiment of the disclosure.

FIG. 11 is a schematic view of a structure of a water outlet body in the switching assembly according to an embodiment of the disclosure.

FIG. 12 is a schematic view of a structure of a connecting ring according to an embodiment of the disclosure.

FIG. 13 is a schematic view of a structure of a shower device in a maximum outflow state according to an embodiment of the disclosure.

FIG. 14 is a schematic view of the structure of the shower device in a medium outflow state according to an embodiment of the disclosure.

FIG. 15 is a schematic view of the structure of the shower device in a turning-off state according to an embodiment of the disclosure.

### DESCRIPTION OF MAIN REFERENCE NUMERALS

toiletries container 1000:
housing 10;
storage tube 11, tube body 110, through hole 110a, toiletries filling hole 110b, plug 111, lip-shaped sealing ring 112;
water outlet connector 12;
filtering net 13;
handle 20, water inlet opening 201;
showerhead body 21, water outlet opening 210;
rotating disc 301, first water outlet hole 301a, inserted shaft 301b;
water splitter piece 302, second water outlet hole 302a, water splitter piece central hole 302b;
toggle 303, toggle claw 303a;
toggle base 304, claw hole 304a, claw extending hole 304b, shaft hole 304c;
water outlet body 305, water outlet channel 305a, water passing hole 305b, water outlet body central hole 305c;
connecting ring 4, toggle hole 41.

### DESCRIPTION OF THE EMBODIMENTS

The accompanying drawings in the embodiments of the disclosure are included to provide a clear and complete description of the technical solutions provided in the embodiments of the disclosure. Obviously, the described embodiments are preferred embodiments of the disclosure, and should not be regarded as exclusion of other embodiments. According to the embodiments of the disclosure, all other embodiments obtained by a person having ordinary skill in the art without any creative work fall within the scope of the disclosure seeking to protect.

Unless otherwise clearly defined in the claims, specification, and the above-mentioned drawings of the disclosure, the terms “first”, “second”, or “third” and so on are used to distinguish different objects, not used to describe a specific order.

Unless otherwise clearly defined in the claims, specification, and the above-mentioned drawings of the disclosure, for location words, such as the use of the terms “center”, “transverse”, “perpendicular”, “horizontal”, “vertical”, “top”, “bottom”, “inner”, “outer”, “upper”, “lower”, “front”, “rear”, “left”, “right”, “clockwise”, “counterclockwise”, and other indication orientations or positional relationships are based on the orientations and positional relationships shown in the drawings, are provided to facilitate the description of the disclosure and simplify the description, and are not intended to indicate or imply that the indicated device or element must have a specific orientation or be constructed and operated in a specific orientation, so cannot be understood as limiting the specific protection scope of the disclosure.

Unless otherwise clearly defined in the claims, specification, and the above-mentioned drawings of the disclosure, if the term “fixedly connected” or “fixed connection” is used, it should be understood in a broad sense, that is, any connection method without displacement relationship and relative rotation relationship between the two, that is, including non-removable fixed connection, removably fixed connection, connected as a whole, and fixed connection through other devices or components.

In the claims, specification, and the above-mentioned drawings of the disclosure, if the words “include”, “have”, and variations thereof are used, it is intended to indicate “include but not be limited to”.

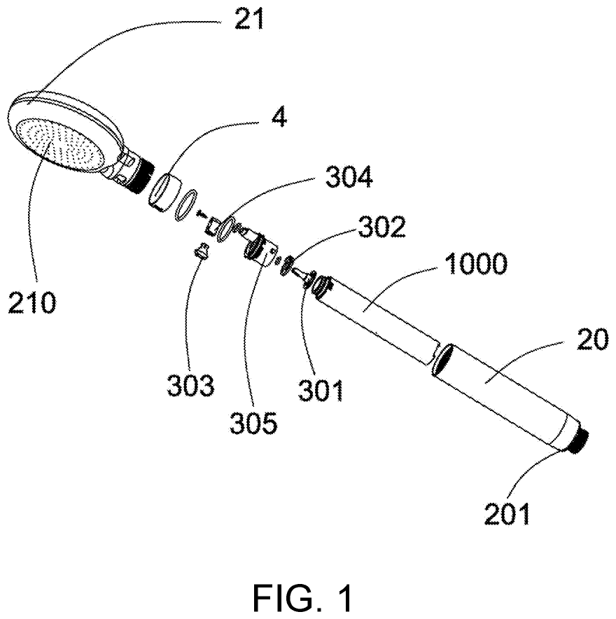

With reference to FIG. 1, FIG. 1 illustrates a skin-beautifying shower device, and the skin-beautifying shower device includes a handle 20, a showerhead body 21, a connecting ring 31, and a toiletries container 1000 and a switching assembly disposed in the handle 20.

Herein, the toiletries container 1000 includes a housing 10, a storage tube 11, a water outlet connector 12, and a filtering net 13.

In this embodiment, the housing 10 is in a round tube shape, and other shapes such as an elliptical tube shape, a square tube shape, and the like for the carrying housing 10 are not excluded. The housing 10 is provided with a water inlet end and a water outlet end. One end of the housing 10 adjacent to the water outlet connector 12 is the water outlet end, and the other end of the housing 10 away from the water outlet connector 12 is the water inlet end, and clean water flows into the housing 10 through the water inlet end.

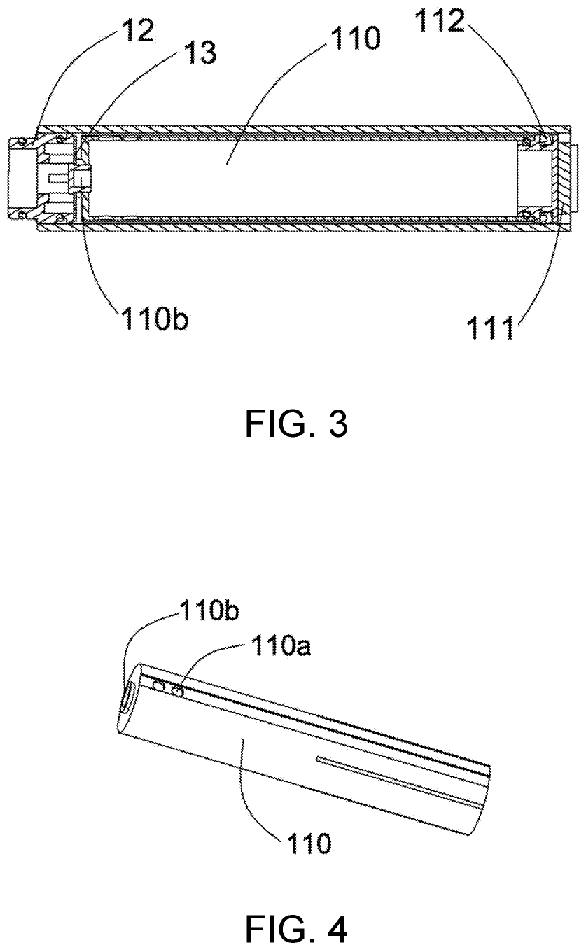

As shown in FIG. 3 to FIG. 4, in this embodiment, at least one end of the storage tube 11 is required to be enclosed and configured in the housing 10. To be specific, the storage tube 11 includes a tube body 110, a plug 111, and a lip-shaped sealing ring 112. An inner chamber of the tube body 110 is configured to accommodate toiletries. In this embodiment, paste-like toiletries are the toiletries accommodated in the inner chamber, and the paste-like toiletries are dissolved in clean water into a toiletries solution.

In this embodiment, the tube body 110 is a round tube shape, and certainly other shapes such as an elliptical tube shape, a square tube shape, and the like for the carrying tube body 110 are not excluded. An inner diameter of the tube body 110 is required to be slightly less than an inner diameter of the housing 10, such that the tube body 110 may be inserted into the housing 10 and a gap may exist between an outer wall of the tube body 110 and an inner wall of the housing 10. The water outlet end of the tube body 110 facing the housing 10 is provided with a toiletries filling hole 110b, so that a user may fill the paste-like toiletries into the inner chamber of the tube body 110. The toiletries filling hole 110 has a moderate hole diameter, such that filling may be conveniently carried out, and spilling may not easily occur. In this embodiment, the tube body 110 is provided with two groups of through holes 110a (not fully shown in the drawing) in the axial direction, and each group of the through holes 110a surrounds the outer wall of the tube body 110 with two through holes 110a. The through holes 110a are used for inflow of clean water or outflow of the subsequent toiletries solution. Certainly, more than 2 groups of through holes 110a may be arranged, and a number of through holes 110a in each group may also be more than two, and that dissolving efficiency of the paste-like toiletries by clean water may be further improved. Herein, each group of the through holes 110a is arranged around the outer wall of the tube body 110 to reduce the risk of poor circulation due to blocking of the through holes 110a in a specific direction or in several directions.

The plug 111 is disposed on one end of the tube body 110 away from the water outlet connector 12 to seal and block one end of the tube body 110 facing the water inlet end, such that the tube body 110 and the plug 111 are matched to form an independent toiletries accommodating chamber, and that replacing and filling may be separately and conveniently performed on the storage tube 11.

As shown in FIG. 6, in this embodiment, the lip-shaped sealing ring 112 is hermetically connected to the plug 111 and the inner wall of the housing 10. One surface of a side wall of the lip-shaped sealing ring 112 facing the water inlet end is an outer side surface, and one surface facing the water outlet end is an inner side surface. Further, a portion of the lip-shaped sealing ring 112 facing the water inlet end is a closing portion, and a portion facing the water outlet end is an opening portion. An opening of the lip-shaped sealing ring 112 faces the water outlet end of the housing 10, and in this way, the toiletries solution may flow out from the water outlet end of the housing 10 in one direction and may not flow back to the water inlet end, thereby preventing waste of the toiletries solution and pollution of clean water. The lip-shaped sealing ring 112 is made of an elastic material such as rubber.

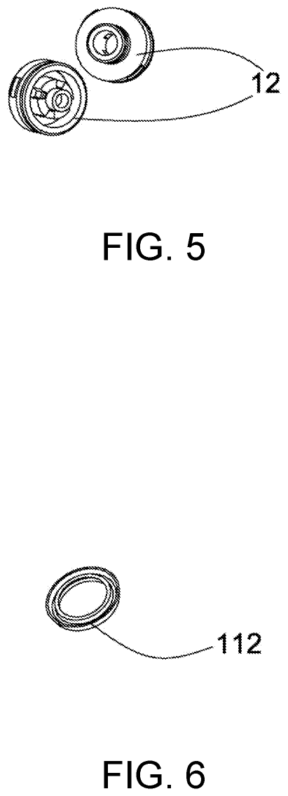

As shown in FIG. 5, in this embodiment, a third water passage is provided in a center of the water outlet connector 12. The water outlet connector 12 and the inner wall of the housing 10 are hermetically connected to the water outlet end of the housing 10 and are configured to hermetically block the toiletries filling hole 110b provided in the tube body 110.

The filtering net 13 is disposed between the water outlet end of the housing 10 and the water outlet connector 12, and is configured to filter incompletely-dissolved toiletries particles. The filtering net 13 only allows the completely-dissolved toiletries solution to pass through and flow out to the third water passage of the water outlet connector 12.

As shown in FIG. 3, assembling of the toiletries container 1000 is described as follows.

The plug 111 hermetically blocks one end of the tube body 110 facing the water inlet end to form the independent toiletries accommodating chamber. The paste-like toiletries are filled into the toiletries accommodating chamber through the toiletries filling hole 110b. In this embodiment, a filling capacity is determined based on a maximum amount of liquid that can be contained in the tube body 110, and the entire tube may be filled with toiletries as needed, thus the filling capacity is greatly increased. The paste-like toiletries are independently filled in the storage tube 11, that is, filling is not related to the housing 10, filling may thus be easily and conveniently performed. The filled storage tube 11 is placed inside the housing 10, and the storage tube 11 and the housing 10 are coaxially arranged. A gap provided between an outer wall of the storage tube 11 and the inner wall of the housing 10 form a first water passage communicating with the water inlet end and the water outlet end.

Herein, in this embodiment, the lip-shaped sealing ring 112 is sleeved on a protruding portion of the plug 111 protruding towards the water inlet end, such that the lip-shaped sealing ring 112 is hermetically connected to the inner wall of the housing 10. The opening of the lip-shaped sealing ring 112 faces the water outlet end. In this embodiment, since a gap required by the first water passage is small, a large accommodating space may thus be provided by the storage tube 11, and more paste-like toiletries may thereby be filled.

Preferably, if a length of the plug 111 is shorter than or equal to a length of the tube body 110, the lip-shaped sealing ring 112 may also be sleeved on one side of the tube body 110 adjacent to the water inlet end, and the lip-shaped sealing ring 112 may still be hermetically connected to the inner wall of the housing 10 in this way. The lip-shaped sealing ring 112 in this arrangement also plays a role in controlling the one-way flowing of water flow.

Next, the filtering net 13 is sleeved between the water outlet connector 12 and the tube body 110. The water outlet connector 12 and the inner wall of the housing 10 are hermetically connected to the water outlet end of the housing 10, and the water outlet connector 12 hermetically blocks the toiletries filling hole 110b provided in the tube body 11. In this way, two ends of the storage tube 11 are enclosed and configured in the housing 10, and that the third water passage provided in the water outlet connector 12 is kept to communicate with the first water passage.

The handle 20 is provided with a water inlet opening 201 configured to allow clean water to flow in. The showerhead body 21 is provided with a water outlet opening 210 configured to allow shower water to flow out. In this embodiment, the shower water is clean water or the toiletries solution.

The switching assembly includes a rotating disc 301, a water splitter piece 302, a toggle 303, a toggle base 304, and a water outlet body 305.

As shown in FIG. 8, the rotating disc 301 is provided with a first water outlet hole 301a communicating with the first water passage and configured to allow the toiletries solution to flow through. A center of the rotating disc 301 is further provided with an inserted shaft 301b, and the inserted shaft 301b is inserted in the water splitter piece 302 and the toggle base 304.

As shown in FIG. 8, the water splitter piece 302 is provided with a second water outlet hole 302a communicating with the water outlet opening 201, and the toiletries solution flows out into the water outlet body 305 through the first water outlet hole 301a and the second water outlet hole 302a aligned with each other. The water splitter piece 302 is further provided with a water splitter piece central hole 302b configured to allow the inserted shaft 301b of the rotating disc 301 to be inserted in.

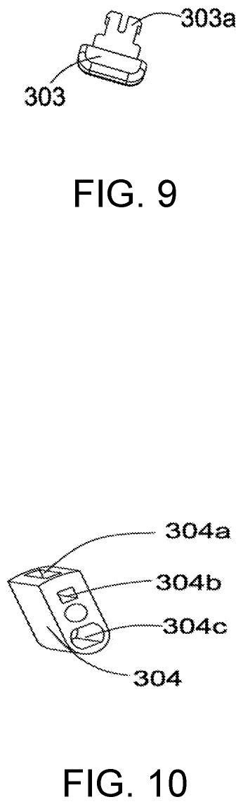

As shown in FIG. 9, one end of the toggle 303 is provided with a toggle handle, and the toggle handle radially passes through a toggle hole 41 provided in a connecting ring 4 and then extends out of the handle 20 to facilitate toggling and switching performed by the user. The other end of the toggle 303 is provided with toggle claws 303a configured to be engaged with the toggle base 304, such that the toggle 303 is fixedly connected to the toggle base 304. That is, one end of the toggle 303 is engaged with the toggle base 304, and the other end of the toggle 303 radially extends out of the handle 20.

As shown in FIG. 10, one end of the toggle base 304 adjacent to the toggle 303 is provided with a claw hole 304a configured to allow the toggle claws 303a of the toggle 303 to extend therein. After the toggle claws 303a extend in the claw hole 304a, hook portions of the toggle claws 303a respectively extend out of claw extending holes 304b due to force disappearing, and then are engaged with the toggle base 304. The claw extending holes 304b are respectively provided on both sides of the toggle base 304. The toggle base 304 is further provided with a shaft hole 304b for allowing the inserted shaft 301b of the rotating disc 301 to be inserted in, so that the rotating disc 301 and the toggle base 304 may be connected in a non-rotational manner. Herein, each of the inserted shaft 301b and the shaft hole 304b is provided with a linear segment matched with each other, so that the inserted shaft 301b and the shaft hole 304b are closely matched.

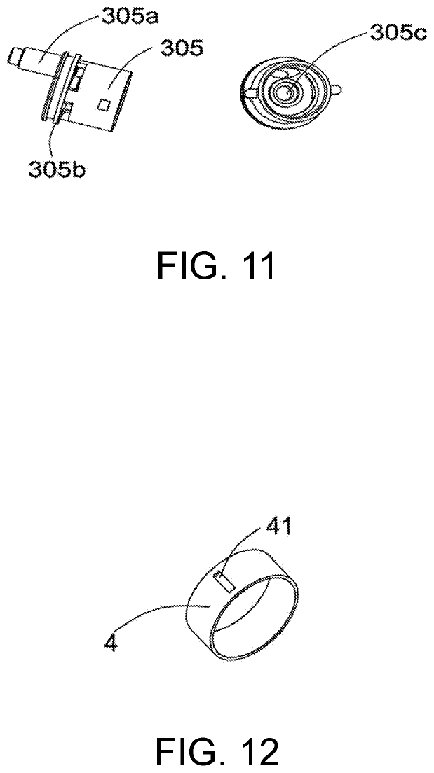

As shown in FIG. 11, the water outlet body 305 is provided with a water outlet channel 305a communicating with the water outlet opening 210 for allowing the mixed toiletries solution and clean water to flow out to the water outlet opening 210. A side wall of the water outlet body 305 is provided with a water passing hole 305b configured to allow clean water to flow into the water outlet body 305. Further, a center of the water outlet body 305 is further provided with a water outlet body central hole 305c configured to allow the inserted shaft 301b of the rotating disc 301 to be inserted in.

As shown in FIG. 12, the connecting ring 4 is provided with the toggle hole 41 to allow the toggle 303 to extend out, and the connecting ring 4 is sleeved outside the handle 20. In this embodiment, the connecting ring 4 is sleeved outside a junction between the handle 20 and the showerhead body 21.

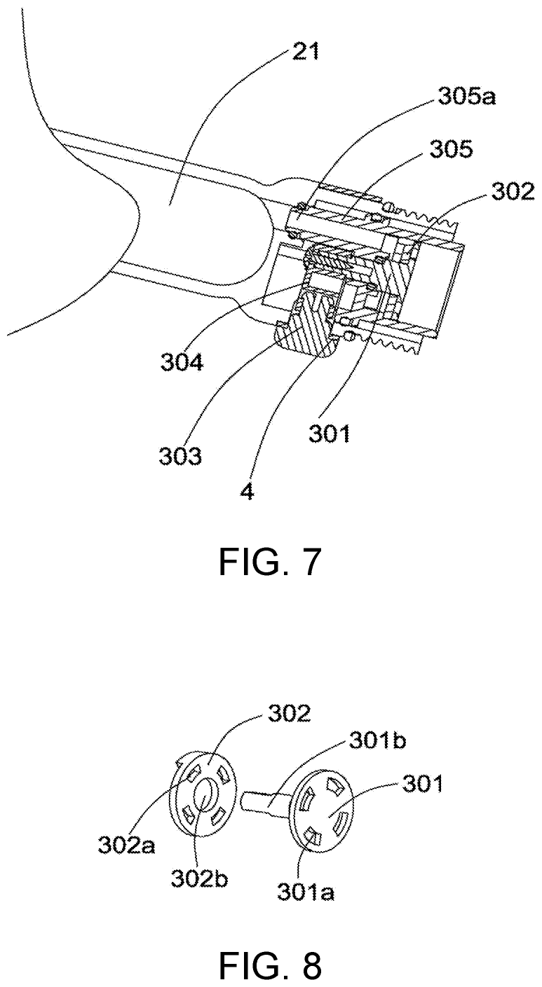

As shown in FIG. 7, in this embodiment, assembling of the switching assembly is provided as follows. The toggle claws 303a of the toggle 303 are pinched to extend into the claw hole 304a of the toggle base 304. After releasing the hand, the hook portions on both sides of the toggle claws 303a are engaged with the claw extending holes 304 and then are engaged with the toggle base 304.

The inserted shaft 301b of the rotating disc 301 is non-rotatably connected to the shaft hole 304b of the toggle base 304 after sequentially penetrating through the water splitter piece central hole 302b and the water outlet body central hole 305b. That is, the water splitter piece 302 is mounted between the rotating disc 301 and the water outlet body 305, and the water splitter piece 302 is non-rotatably connected to the water outlet body 305. The second water outlet hole 302a of the water splitter piece 302 always communicates with the water outlet channel 305a of the water outlet body 305. As such, the toggle handle of the toggle 303 may be toggled to drive the rotating disc 301 to rotate around the axis of the handle 20, so as to control a communication area between the first water outlet hole 301a of the rotating disc 301 and the second water outlet hole 302a of the water splitter piece 302. To be specific, that is, after the rotating disc 301 and the water splitter piece 302 rotate and after the first water outlet hole 301a and the second water outlet hole 302a intersect, non-overlap portions of the first water outlet hole 301a and the second water outlet hole 302a form a water passing through hole for allowing the toiletries solution to flow through. A water passing area of the water passing through hole is the communication area between the first water outlet hole 301a and the second water outlet hole 302a. A size of the communication area depends on a rotating angle of the rotating disc 301 relative to the water splitter piece 302. Outflow amount of the toiletries solution increases as the communication area increases. When the first water outlet hole 301a and the second water outlet hole 302a are completely misaligned, the outflow of the toiletries solution is stopped.

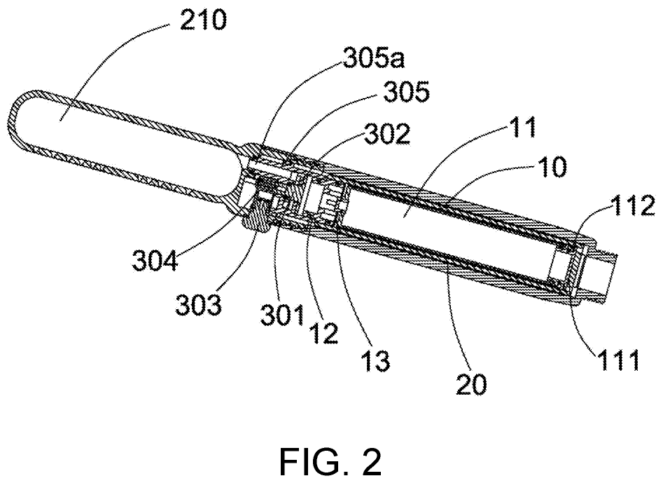

As shown in FIG. 1 and FIG. 2, assembling of the skin-beautifying shower device is provided as follows. The toiletries container 1000 and the switching assembly are assembled first according to the above-mentioned arrangement of assembling.

Next, the assembled toiletries container 1000 is entirely inserted and fixed into the handle 20, so that the toiletries container 1000 and the handle 20 are coaxially arranged. To be specific, after the toiletries container 1000 and the handle 20 are fixed, the water inlet end of the housing 10 communicates with the water inlet opening 201. A gap is provided between the outer wall of the housing 10 and an inner wall of the handle 20 to form a second water passage.

Afterwards, the assembled switching assembly is entirely installed in the handle 20, and the switching assembly and the handle 20 are coaxially arranged as well. To be specific, after the switching assembly and the handle 20 are fixed, one end of the third water passage provided in the water outlet connector 12 communicates with the first water passage, and the other end of the third water passage communicates with the first water outlet hole 301a of the rotating disc 301. One end of the second water passage communicates with the water inlet opening 201, and the other end of the second water passage always communicates with the water passing hole 305b of the water outlet body 305. The water outlet channel 305a of the water outlet body 305 always communicates with the water outlet opening 210 of the showerhead body 21.

Finally, the connecting ring 4 is sleeved outside the handle 20, and the toggle handle of the toggle 303 extends out of the handle 20 through the toggle hole 41 of the connecting ring 4. The handle 20 is threadedly connected to the showerhead body 21, and that is, the skin-beautifying shower device is assembled.

Herein, junctions between the components in the skin-beautifying shower device are all hermetically connected, and preferably, a rubber O-shaped ring may be used for sealing.

The way of using the skin-beautifying shower device is provided as follow.

When the skin-beautifying shower device is turned on, clean water flows into the water inlet end of the housing 10 after flowing through the water inlet opening 201 of the handle 20. When the clean water flows through the closing portion of the lip-shaped sealing ring 112, water flow of the clean water may generate a water pressure on the outer side surface of the lip-shaped sealing ring 112. The side wall of the lip-shaped sealing ring 112 thereby generates elastic deformation and compresses towards a shaft center due to an action of the water flowing towards the water outlet end. As such, a water passing gap is formed between the side wall of the lip-shaped sealing ring 112 and the inner wall of the housing 10, and that the clean water is thus allowed to flow into the first water passage. Further, a water pressure is generated on the inner side surface of the lip-shaped sealing ring 112 after the clean water flows into the first water passage, so that the side wall of the lip-shaped sealing ring 112 is stretched by the water flowing towards the water inlet end and then abuts against the inner wall of the housing 10. The lip-shaped sealing ring 112 is thereby closely attached to the inner wall of the housing 10 to form water sealing, and that the water flow in the first water passage cannot flow back to the water inlet. That is, the clean water may only flow into the first water passage through such a lip-shaped sealing member 12 in one direction.

The clean water in the first water passage flows into a tube of the tube body 110 through the through holes 110a provided on the outer wall of the tube body 110 to dissolve the paste-like toiletries in the tube, so that the tube of the tube body 110 is always kept in a filled state. In this embodiment, the outer wall of the tube body 110 is surrounded with the plurality of through holes 110a. That is, the clean water may flow into an internal portion of the tube body 110 through each through hole 110a, and that a dissolution speed of the paste-like toiletries may thus be effectively improved.

After the paste-like toiletries are dissolved in the clean water into the toiletries solution, since the flow rate in the tube body 110 is slower, and the flow rate outside the tube body 110 is faster, based on the Venturi principle, the toiletries solution inside the tube body 110 is sucked out from the through holes 110a, that is, the toiletries solution flows out into the first water passage. In this embodiment, since the plurality of through holes 110a are provided around the outer wall of the tube body 110, even if part of the through holes 110a in any direction are blocked by the paste-like toiletries, the smooth flow of the water flow as a whole is not be affected, and the normal use of the toiletries container 1000 is effectively ensured.

To be specific, since the opening of the lip-shaped sealing ring 112 faces the water outlet end, the toiletries solution may only flow towards the water outlet end to flow out from the first water passage to the third water passage of the water outlet opening 12 and may not flow backwards from the first water passage to the water inlet end, and that the toiletries solution is prevented from being wasted and polluting the clean water. Further, when the toiletries solution flows from the first water passage to the water outlet end, the filtering net 13 may filter the incompletely dissolved toiletries particles, and only the completely dissolved toiletries solution may be allowed to pass through. The toiletries particles attached to the filtering net 13 may not flow out to the third water passage of the water outlet connector 12 until being completely dissolved into the toiletries solution, so that utilization of the toiletries is effectively improved.

In this embodiment, the skin-beautifying shower device is provided with three switching gears to control the outflow amount of the toiletries solution, a first gear is a maximum outflow state, a second gear is a medium outflow state, and a third gear is a turning-off state. Certainly, it is not ruled out that by adjusting the numbers or hole diameters of the first water outlet hole 301a of the rotating disc 301 and the second water outlet hole 302a of the water splitter piece 302, subtle adjustment to the gears may also be achieved in various other ways, so as to better satisfy the needs of the user.

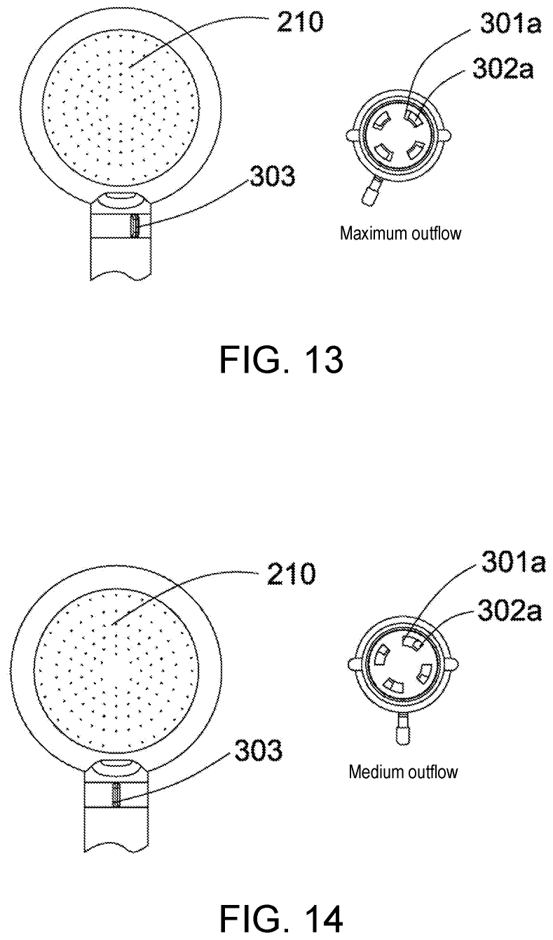

As shown in FIG. 13, when the user needs to use a large amount of toiletries solution, the user only needs to use a single finger to toggle the toggle 303 to the first gear (maximum outflow state). The rotating disc 301 is thereby driven to rotate around the axis of the handle 20, and in this way, the communication area between the first water outlet hole 301a of the rotating disc 301 and the second water outlet hole 302a of the water splitter piece 302 is the maximum, that is, the outflow amount of the toiletries solution is the largest at this time.

To be specific, after the toiletries solution flows out from the first water passage to the water outlet connector 12, the toiletries solution then flows from the third water passage of the water outlet connector 12 and sequentially flows through the first water outlet hole 301a of the rotating disc 301 and the second water outlet hole 302a of the water splitter piece 302, and then flows into the water outlet body 305. Herein, since the water passing hole 305b of the water outlet body 305 always communicates with the second water passage, the clean water always flows into the water outlet body 305 through the second water passage. As such, after the toiletries solution and the clean water are mixed in the water outlet body 305, the toiletries solution and the clean water flow outside the water outlet opening 210 of the showerhead body 21 together through the water outlet channel 305a of the water outlet body 305, such that the user may conveniently use the skin-beautifying shower device to spray the toiletries solution. At this time, the user may spray a larger amount of toiletries solution at one time.

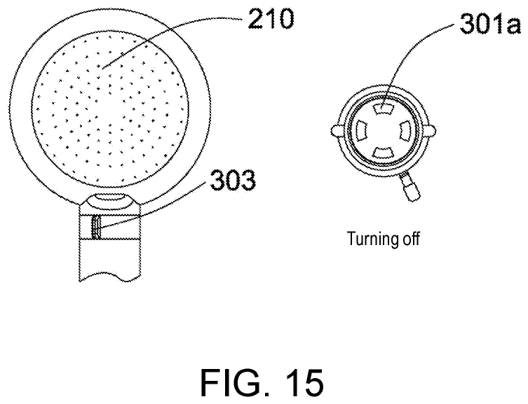

As shown in FIG. 14, when the user needs to use a small amount of toiletries solution, the user only needs to use a single finger to toggle the toggle 303 to the second gear (medium outflow state). The rotating disc 301 is thereby driven to rotate around the axis of the handle 20, and in this way, the communication area between the first water outlet hole 301a of the rotating disc 301 and the second water outlet hole 302a of the water splitter piece 302 is the medium area, that is, the outflow amount of the toiletries solution is medium at this time, and the user may thus spray a small amount of toiletries solution.

Herein, the outflow path of the toiletries solution after switching is as described above, and description thereof is not repeated.

As shown in FIG. 15, when the user does not need to use the toiletries solution, the user only needs to use a single finger to toggle the toggle 303 to the third gear (turning-off state). The rotating disc 301 is thereby driven to rotate around the axis of the handle 20, and in this way, the first water outlet hole 301a of the rotating disc 301 and the second water outlet hole 302a of the water splitter piece 302 are completely misaligned, that is, the outflow of the toiletries solution is blocked at this time. Since the water passing hole 305b of the water outlet body 305 always communicates with the second water passage, the clean water always flows into the water outlet body 305 through the second water passage. The clean water flows out through the water outlet channel 305a of the water outlet body 305 to the outside of the water outlet opening 210, so the user uses the clean water only at this time.

As described above, after the skin-beautifying shower device is turned on, the user may control the outflow amount of the toiletries solution as needed only by switching with a single finger, and it thus can be seen that a simple operation is provided and such an operation is suitable and convenient to be performed during a shower.

In view of the foregoing, the skin-beautifying shower device provided by the embodiments of the disclosure may be filled with toiletries independently, ensure smooth water flow, and facilitate the control of the water flow by a user by means of one hand only, thereby not only reducing the waste of the toiletries solution, but also improving the user experience.

Although the description of the specification and embodiments provided above serve to explain the scope of the disclosure, such description should not be construed as limitations on the scope of the disclosure. Through inspiration provided by the disclosure or the embodiments, modifications, equivalents, or other improvements of the embodiments or part of the technical features of the disclosure obtained by a person having ordinary skill in the art by combining general knowledge and common technical knowledge in the art and/or related art through logical analyses, reasoning, or limited tests fall within the protection scope of the disclosure.

1. A skin-beautifying shower device, comprising a handle and a showerhead body fixedly connected to the handle, wherein the handle is provided with a water inlet opening, the showerhead body is provided with a water outlet opening, the skin-beautifying shower device further comprising a toiletries container and a switching assembly provided in the handle,
the toiletries container comprises a housing and a storage tube, the housing is provided with a water inlet end and a water outlet end, the storage tube is placed in the housing with at least one end thereof being enclosed, and a gap is defined between an outer wall of the storage tube and an inner wall of the housing to form a first water passage communicating with the water inlet end and the water outlet end;
the switching assembly comprises a rotating disc, a water splitter piece, and a toggle, the rotating disc is provided with a first water outlet hole communicating with the first water passage, the water splitter piece is provided with a second water outlet hole communicating with the water outlet opening, and the toggle radially extends out of the handle and drives the rotating disc to rotate around an axis of the handle to control a communication area between the first water outlet hole and the second water outlet hole.

2. The skin-beautifying shower device according to claim 1, wherein the switching assembly further comprises a water outlet body, the water outlet body is non-rotatably connected to the water splitter piece, the water outlet body is provided with a water outlet channel communicating with the water outlet opening, the water splitter piece is disposed between the rotating disc and the water outlet body, and the second water outlet hole always communicates with the water outlet channel.

3. The skin-beautifying shower device according to claim 2, wherein the water inlet end of the housing communicates with the water inlet opening, a gap is defined between an outer wall of the housing and an inner wall of the handle to form a second water passage always communicating with the water inlet opening, and a side wall of the water outlet body is provided with a water passing hole always communicating with the second water passage.

4. The skin-beautifying shower device according to claim 2, wherein the switching assembly further comprises a toggle base, one end of the toggle is engaged with the toggle base, the other end of the toggle radially extends out of the handle, the toggle base is provided with a shaft hole, the rotating disc is provided with an inserted shaft, and the inserted shaft of the rotating disc penetrates through the water splitter piece and the water outlet body, and is non-rotatably connected to the shaft hole of the toggle base.

5. The skin-beautifying shower device according to claim 1, wherein the outer wall of the storage tube is surrounded with a plurality of through holes.

6. The skin-beautifying shower device according to claim 5, wherein the toiletries container is further provided with a water outlet connector, the water outlet connector is provided with a third water passage communicating with the first water passage at one end, and communicating with the first water outlet hole at the other end, and the water outlet connector and the inner wall of the housing are hermetically connected to the water outlet end of the housing.

7. The skin-beautifying shower device according to claim 6, wherein one end of the storage tube facing the water outlet end is provided with a toiletries filling hole, and the water outlet connector hermetically blocks the toiletries filling hole.

8. The skin-beautifying shower device according to claim 7, wherein the storage tube comprises a tube body and a plug, and the plug hermetically blocks one end of the tube body facing the water inlet end.

9. The skin-beautifying shower device according to claim 8, wherein the storage tube further comprises a lip-shaped sealing ring, and the lip-shaped sealing ring is disposed on one side of the tube body adjacent to the water inlet end or a protruding portion of the plug protruding towards the water inlet end, such that the lip-shaped sealing ring is hermetically connected to the inner wall of the housing, and an opening of the lip-shaped sealing ring faces the water outlet end.

10. The skin-beautifying shower device according to claim 9, wherein at least two groups of the through holes are provided in an axial direction of the storage tube, and each group of the through holes is provided with a plurality of through holes around the outer wall of the storage tube.

11. The skin-beautifying shower device according to claim 1, further comprising a connecting ring, wherein the connecting ring is sleeved outside the handle, and the connecting ring is provided with a toggle hole, and the toggle extends out of the toggle hole.
